(19) United States
(12) Patent Application Publication
(10) Pub. No.: US 2007/0052533 A1
(43) Pub. Date: Mar. 8, 2007

(54) METHODS AND APPARATUS FOR A HAZARD WARNING SYSTEM

(76) Inventor: Victoria Glazer, Chesterfield, VA (US)

Correspondence Address: SNELL & WILMER, 400 EAST VAN BUREN, ONE ARIZONA CENTER, PHOENIX, AZ, 85004-2202, US

(21) Appl. No.: 11/161,972

(22) Filed: Aug. 24, 2005

(51) Int. Cl. H04Q 7/00

(52) U.S. Cl. 340/539.11

(57) ABSTRACT

Methods and apparatus for providing alerts or warnings of a variety of hazards are disclosed. A warning system is disclosed that continuously operates and is configured to receive and analyze advisory notices from publicly and/or privately available broadcasts that do not require registration of the device and/or user. Continuous operation provides the warning system user with appropriate warnings, even when the user cannot personally monitor the advisory notices, such as when the user is asleep.

### FIELD OF INVENTION

The present invention relates generally to methods and apparatus for providing alerts or warnings of a variety of hazards.

### BACKGROUND OF INVENTION

Existing methods of alerting the public to hazards and important warnings typically involve the public listening to a public broadcast medium (e.g., television, radio, or internet) or registering for a notification service such as a paging system or internet alerts. Conventional systems also often involve the user activating the medium through which the warnings are given, such as, for example, turning on the television, radio, paging, or internet device. Notification from systems which include registration and/or payment of subscription fees are typically only available to registered users. Accordingly, a person may not receive notice of potential or imminent hazards when the television and/or radio are turned off, or when the person does not have access to a television, radio, or registered notification service. Thus, a need exists for an “always on” alert system that is continuously active and that does not require registration.

### SUMMARY OF INVENTION

The invention generally includes a warning system that receives advisory notices from a variety of sources, interprets the notices, and provides an appropriate alarm based on, for example, the user's location, user preferences, type of warning, and/or proximity of the hazard to the user. In one embodiment, the warning system is “always on” in that it operates continuously. The invention also comprises methods for continuously receiving advisory notices describing the location of the hazard, comparing the hazard location to the user's location, and/or activating an alarm when the hazard's location is within a predetermined distance of the user's location. In one embodiment, the warning system is stationary and the user location is provided by the warning system user. In another embodiment, the warning system is mobile and the user location is provided by a Global Positioning System (“GPS”) receiver. In another embodiment, a portion of the system is mobile. The invention may be a stand-alone system and/or incorporated into another system.

### BRIEF DESCRIPTION OF THE DRAWINGS

A more complete understanding of the present invention may be derived by referring to the detailed description when considered in connection with the Figures, wherein like reference numbers refer to similar elements throughout the Figures, and:

FIG. 1 is a diagram of a warning system in accordance with one embodiment of the present invention;

FIG. 2 is a more detailed diagram of a warning system with a GPS receiver configured to provide user location, a keyboard for entering user preferences, and an LCD screen to provide feedback to the user in accordance with one embodiment of the present invention;

FIG. 3 is a diagram of a warning system with at least one mobile portion in accordance with one embodiment of the present invention;

FIG. 4 is a diagram of a warning system having a subscription services manager in accordance with one embodiment of the present invention;

FIG. 5 is a flow chart of a method for receiving advisory notices in accordance with one embodiment of the present invention;

FIG. 6 is a flow chart of a method for determining proximity in accordance with one embodiment of the present invention;

FIG. 7 is a flow chart of a method for stationary operation in accordance with one embodiment of the present invention; and,

FIG. 8 is a flow chart of a method for mobile operation in accordance with one embodiment of the present invention.

### DETAILED DESCRIPTION

The detailed description of exemplary embodiments of the invention herein makes reference to the accompanying drawings, which show the exemplary embodiment by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented.

For the sake of brevity, conventional aspects may not be described in detail herein. Furthermore, the component positions shown in the various figures contained herein are intended to represent exemplary functional relationships and/or physical couplings between the various elements. It should be noted that many alternative or additional functional relationships or physical connections may be present in a practical system.

As will be appreciated by one of ordinary skill in the art, the present invention may be embodied as a customization of an existing system, an add-on product, a stand alone system, and/or a distributed system. Accordingly, the present invention may take the form of an entirely hardware embodiment, or an embodiment combining aspects of both software and hardware.

The invention generally includes a warning system that continuously operates and is configured to receive and analyze advisory notices from publicly and/or privately available broadcasts. In one embodiment, the broadcasts do not require registration of the device and/or user. Continuous operation provides the warning system user with appropriate warnings even when the user cannot personally monitor the advisory notices, such as when the user is asleep. Continuous operation, as used herein, includes substantially continuous operation, random operation, a periodic operation, scheduled operation, pinging operation (e.g., Internet Control Message Protocol (ICMP) reply request wherein a ping sends out a ICMP message that requests a reply from another machine and the receipt of the reply is a successful ping) and the like. The warning system obtains the hazard location information from each advisory notice, determines the proximity of the hazard's location to the user's location, and/or warns the user if the hazard is within a predetermined distance. The warning system may be stand alone and/or integrated with other devices, for example, a smoke alarm, a carbon monoxide detector, an employee badge, a pager, a cell phone, any other personal digital assistant, or pervasive computing device. Advisory notices may concern any type of event and/or condition related to, for example, the weather, environment, economy, military, family and the government.

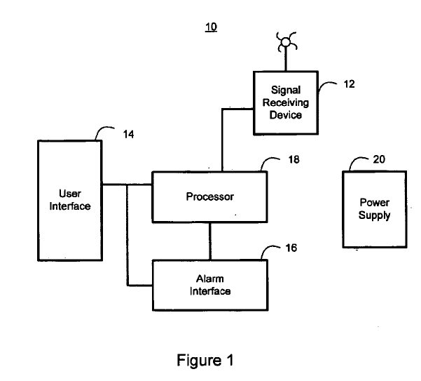

In one embodiment, referring to FIG. 1, a warning system 10 comprises a signal receiving device 12 configured to receive warning signals. A user interface 14 enables the user to provide warning system 10 a user location and other user preferences, such as, for example, a desired proximity, alarm type, alarm volume, hazard type selection, location format, system upgrade activation, and system upgrade verification. A processor 18 interfaces with user interface 14 and signal receiving device 12. Processor 18 may read the user preferences provided through user interface 14 to determine operational parameters, such as, for example, the type of hazards to monitor, the desired proximity, and the type of alarm desired. Processor 18 may also receive advisory information from signal receiving device 12, such as, for example, advisory notices, hazard locations, hazard type, and hazard severity. Processor 18 compares the hazard locations to the user location and when the proximity of the hazard is less than the predetermined distance from the user location, processor 18 activates an alarm interface 16 which in turn activates an alarm. User interface 14 may also interface with alarm interface 16 to enable the user to select, for example, the type of alarms activated, the manner of alarm activation, and manner of operation. Selected components of warning system 10 may be placed in a low power mode and/or sleep mode to conserve energy and then brought into a fully operational mode when desired.

Signal receiving device 12 is any hardware and/or software suitably configured to receive any type of signal sent using any protocol. For example, signal receiving device 12 may receive AM modulated, FM modulated, microwave, analog, digital, spread spectrum, infrared, and/or sonar signals. Signal receiving device 12 may receive signals from any type of broadcasting and/or communication device, for example, radio, satellite, television, analog cable network, digital cable network, local area network, wide area network, internet, and/or wireless network. Signal receiving device 12 may simultaneously and/or serially receive different signal types. Additionally, signal receive device transmits to other devices using any type of signal and/or communication protocol. Signal receiving device 12 receives advisory signals from any source, for example, public or proprietary broadcasts providing open access and/or anonymous broadcast reception, and signals from other warning devices such as, for example, a smoke detector, carbon monoxide detector, radiation detector, or any other suitable detector.

Signal receiving device 12 is configured to receive advisory notices in any format, for example, National Weather Service, National Weather Service with Same Area Message Encoding, Emergency Broadcast System, digital packet with header, internet packet, and proprietary formats. With continuing reference to FIG. 1, signal receiving device 12 is configured to receive RF signals carrying National Weather Service with Same Area Message Encoding advisory notices.

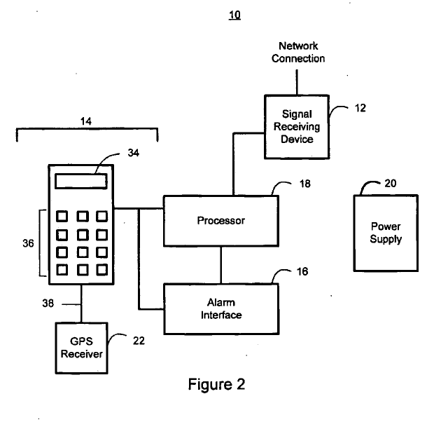

In another embodiment, referring to FIG. 2, signal receiving device 12 receives digital information from a network connection using the TCP/IP protocol. Communication of advisory notices may use any communication protocol, for example, TCP/IP, 802.11, Bluetooth, Ethernet, token ring, IPX, or any other protocol suitable for the application. Advisory notices may carry any type of information, for example, hazard type, hazard location, hazard trajectory, and hazard severity. Signal receiving device 12 may process the advisory notices in any manner. For example, signal receiving device 12 sends advisory notices directly to processor 18, parses the advisory notice information, selectively retains or deletes hazard information, and combines information from different types of received signals and/or hazard formats.

Location information is used to report the location of any object, for example, a hazard, warning system 10, a stationary user, and a plurality of mobile users. Location may be specified in any manner. For example, location may be specified as a zip code, zip code plus a four digit extension, postal code, telephone area code, telephone area code with prefix, street address, and map coordinate, such as, for example, latitude/longitude, Universal Transverse Mercator (“UTM”), Universal Polar Stereographic, Military Grid Reference System, Maidenhead, Ordnance Survey Great Britain, and map coordinate plus a vector. Locations reported as a map coordinate may use any datum, for example, World Geodetic System 1984, North American Datum 1927, and Ordinance Survey British Grid. Location information may be obtained from any source, for example, advisory notices, a person who initializes warning system 10, a warning system user, a cell phone tower triangulation calculation, and a GPS receiver. Warning system 10 may store any number of locations from any source. For example, warning system 10 may store hazard locations for any number of users from advisory notices received over any period of time such as a day, week, or year. Locations are stored and categorized by any criteria, for example, by hazard type, hazard duration, hazard origin, hazard location, hazard path of movement, warning expiration time, user preference, user location, user trajectory of movement, and any other criteria suitable for the application. Location information is received in any suitable format and converted to any other format.

User interface 14 is any hardware and/or software suitably configured to provide information to and/or receive information from warning system 10. For example, user interface 14 may comprise push buttons, push buttons with LEDs, a keypad, a keypad with LCD screen, a serial interface to a computer, a network interface to an entry device on the internet, an RF interface to a remote keypad, an RF interface to a remote device, an infrared interface to a remote control, a telephone, a cell phone, an NMEA interface, and any other interface and/or connection suitable for the application. User interface 14 is used to provide any type of information to warning system 10, for example, user location, warning system 10 location, desired alarm type on a per hazard basis, alarm volume, alarm delay, and advisory notice source selection.

In the exemplary embodiment shown in FIG. 2, user interface 14 comprises an LCD screen 34, a keypad 36, an NMEA connection 38, and a GPS receiver 22. User interface 14 may process user input in any manner and provide any type of information in any format to assist the entry and/or display of user information. For example, user interface 14 may accept a map coordinate for a user location and convert it to a zip code, provide an error display on an LCD screen upon incorrect and/or unintelligible user entries, and/or relay a digital status message over a network connection to a remote user display.

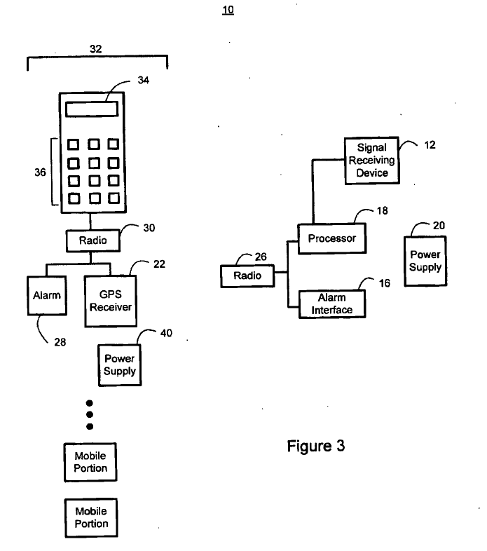

In another embodiment, referring to FIG. 3, user interface 14 comprises a mobile portion 32 and a stationary portion 42. Stationary portion 42 comprises radio 26 that interfaces with processor 18 and alarm interface 16 and power supply 20. Mobile portion 32 comprises LCD screen 34, keypad 36, GPS receiver 22, alarm 28, radio 30, and power supply 40. User information is entered through keypad 36 and relayed by radio 30 to radio 26 for use by a stationary portion 42 of warning system 10. User location is tracked using GPS receiver 22 and also relayed to the stationary portion 42 via radio 30 and radio 26. Stationary portion 42 of warning system 10 compares user location to hazard locations and sends any appropriate warnings to mobile portion 32 by way of radio 26 and radio 30. Upon receipt of a warning signal, alarm 28 activates. Power supply 40 provides continuous, “always on” operation to mobile portion 32. Power supply 20 provides continuous, “always on” operation for stationary portion 42 of warning system 10. Warning system 10 may interface with multiple mobile portions 32, thereby allowing multiple users to receive appropriate warnings based on their location. Mobile portion 32 may be integrated with any type of device, such as, for example, a cell phone, an employee badge, a pager, a GPS receiver, and a handheld electronic device. User interface 14 may interface with processor 18 and/or alarm interface 16 in any manner. Any portion of user interface 14 may be integrated into processor 18 and/or alarm interface 16.

Alarm interface 16 is any hardware and/or software suitably configured to enable the control and/or configuration of at least one alarm. For example, alarm interface 16 may comprise a wire, amplifier, programmable amplifier, serial connection, parallel connection, RF connection, a network connection, memory, logic, and/or infrared LED. Alarm interface 16 may interface with and/or drive any type of alarm, for example, a speaker, light, siren, mechanical shaker, popup window on a computer screen, email notice, and/or vibrator. With continued reference to FIG. 3, alarm interface 16 interfaces with radio 26 which interfaces with radio 30 which interfaces with alarm 28. In such an embodiment, alarm interface 16 sends an appropriate signal to radio 26 which sends the signal by RF waves to radio 30 which receives and sends the signal to alarm 28 which activates and warns the user.

Alarm interface 16 may receive, store, and utilize user preferences on how to control an alarm. For example, alarm interface 16 may record data and/or preferences such as, alarm type on a per hazard basis, alarm volume, alarm delay, and alarm repeat frequency. Alarm interface 16 may also store and utilize mechanical alarm settings such as, for example, vibrations per minute, vibration strength, and any other settings for a given application. Alarm interface 16 may interface with processor 18 in any manner, for example, by serial bus, parallel bus, wireless interface, and infrared interface. Alarm interface 16 may also be integrated with processor 18.

Processor 18 is any hardware and/or software suitably configured to perform any desired or required functions for a given application. For example, processor 18 may be a microprocessor, a programmable logic device, a custom integrated circuit, relays, tuned electronic circuits, a MEMS device, and/or a personal computer with appropriate software. In warning exemplary embodiments, referring to FIGS. 1-3, processor 18 may be a microprocessor with integrated Flash memory, RAM memory, and communication ports configure to interface with user interface 14, alarm interface 16, and signal receiving device 12. In another embodiment, processor 18 comprises separate components of a microprocessor, Flash memory, RAM memory, hard disk drive, network access port, and communication ports.

Processor 18 may be programmed with any language, use any operating system, execute any algorithm, have any amount of storage, and manipulate and/or convert data in any format. Processor 18 may interface with signal receiving device 12, user interface 14, and alarm interface 16 in any manner. Processor 18 may receive data as analog and/or digital signals. Processor 18 may utilize any communication protocol through any interface with any type of component.

Power supply 20 includes any hardware and/or software suitably configured to provide continuous power such that warning system 10 may operate in an “always on” manner. For example, power supply 20 may provide energy from such sources as, for example, electrical line power, a fuel cell, a battery, a solar cell, combustible gases, geothermal heat, and hydraulic power. Power supply 20 may combine sources of energy to provide continuous operation. Power supply 20 may convert one type of energy into another type of energy, for example, solar to electrical, mechanical to electrical, and heat to electrical. Power supply 20 may switch between one source of energy and another source at will and/or when necessary. Power supply 20 may measure, quantify, condition, transform, and/or regulate power in any manner. For example, power supply 20 may accept AC line power, convert the AC power into DC power, transform the power to a lower voltage, and regulate the DC power to be within predetermined values. Power supply 20 may measure the AC current to detect failure of the AC source and switch to another source of energy to provide continuous power. In an exemplary embodiment, power supply 20 uses AC line power as a primary source and rechargeable batteries as a secondary source. In another embodiment, power supply 20 uses an array of solar cells as a primary source and rechargeable batteries as a secondary source. In yet another embodiment, power supply 20 uses an AC line power as a primary source, an array of solar cells as a secondary source, and rechargeable batteries as a tertiary source. In an embodiment comprising mobile portion 32, a power supply 40 may comprise any configuration suitable to a mobile application.

In an exemplary embodiment, warning system 10 receives advisory notices from a publicly available source that does not require registration of the user and/or warning system 10 with the entity providing the advisory notices. For example, in an exemplary embodiment, warning system 10 receives advisory notices from the U.S. National Weather Service. Warning system 10 may also receive notices from sources that require a subscription fee, but still do not require registration.

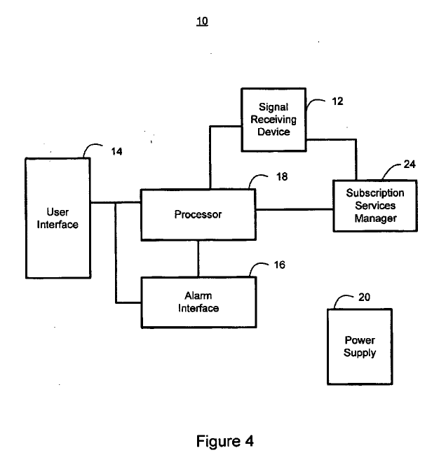

In one embodiment, referring to FIG. 4, warning system 10 additionally comprises a subscription services manager 24 configured to manage and/or make available advisory notices from sources that require a subscription. Subscription services manager 24 may perform any action to provide access to advisory notices from a subscription service. For example, subscription services manager 24 may provide access to advisory notices available under a selected subscription plan, convert advisory notices from one format to any format desired by processor 18, provide notice of new services available from the subscription service, download distinct alarm tones for use by alarm interface 16, provide network and/or wireless access between the subscription service and warning system 10, and provide phone access, whether by land-line or cellular network, between the subscription service and warning system 10. Subscription services manager 24 may also operate to provide advisory notices that augment and/or enhance information received from public sources that do not require registration. For example, a subscription service may provide advisory notices that augment the advisory notices provided by the U.S. National Weather Service. In such an embodiment, signal receiving device 12 receives signals from both the U.S. National Weather Service and the subscription service. Augmentation and/or combination of the advisory notices from both sources are performed by subscription services manager 24 and/or the processor 18.

The present invention is described herein with reference to block diagrams and flowchart illustrations of methods, apparatus (e.g., systems), and computer program products according to various embodiments. It will be understood that method can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the method functions.

Warning system 10 may perform its desired functions using any algorithm and/or series of steps suitable for a given application. For example, any methods may be used to determine proximity of hazard locations to the user locations, interact with a user through user interface 14, advise the user of new services available through a publicly available and/or a subscription service source, store advisory notices, store user locations, activate alarms, and manipulate advisory notices. Separate methods for accomplishing any given task may be combined with the methods of any other task in a parallel and/or serial manner. For example, advisory notices may be received and processed simultaneous to accepting user input. Exemplary methods for use in an exemplary warning system are given below.

Eliminating or reducing the requirements for registering a warning system capable of receiving advisory notices from a subscription service provides a variety of benefits. For example, eliminating registration eliminates any link between the user location and the registration location, thereby enabling shipment of warning system 10 to any location at any time without updating registration. Eliminating registration also increases ease of use, decreases barriers to wide spread public acceptance, enables users to preserve their privacy, and encourages subscription services to develop a national advisory system as opposed to local services based on registration address.

Even without warning system 10 registration, payment for subscription services may be made in any manner, even anonymously. For example, a subscription service may sell subscription services manager 24 as a separate module and/or warning system 10 incorporating subscription services manager 24 with the subscription fee included in the price of the sale. Methods of enabling fee subscription services without requiring registration may also include programming each subscription services manager 24 with a unique identification number. Payment for services may be tracked by subscription services manager's 24 unique number and not by the name, address, and/or location of the system user. A user may pay for desired services in any manner, such as, for example, with cash, credit card, money order, check, third party payment service, and by purchase of a subscription service related pre-paid card, transaction instrument or account code. Users desiring anonymity may pay with cash, through a third party payment service, and/or by subscription service related pre-paid card. As used herein, any transaction instrument (e.g., charge card, credit card, debit card, transponder, smart card) or account code may be used to purchase services. As such, “payment”, “issue a debit”, “debit” or “debiting” may refer to either causing the debiting of a stored value or prepaid card-type financial account, or causing the charging of a credit or charge card-type financial account, as applicable.

Subscription services manager 24 may be advised of the services purchased by the user in any manner, for example, swiping the pre-paid services card in warning system 10, embedding a message to enable services as part of advisory notices, and connecting subscription services manager 24 to a subscription services database, for example, by telephone, network, internet, or any other suitable connection.

Not requiring registration of warning system 10 that receives advisory notices from public and/or subscription service eliminates the obvious method of contacting users to advise them of new services. However, other methods may be used to advise users of new services. For example, notice of new services may be embedded in advisory notices, provided via a special signal and/or communication link, and provided by a telephone service describing new services. Notice of new services may be displayed to the user through user interface 14. Users may purchase new services in any manner including the methods described above for purchasing subscription services. Warning system 10 may be advised of and enabled to access new services in any manner including the methods described above. New services may include, for example, alarm tones, advisory messages for particular hazards, signal types usable by the signal receiving device 12, number of users supported by the system, and user interface 14 enhancements.

Initialization and/or reset of warning system 10 and/or a mobile portion 32 may be accomplished using any algorithm and/or series of steps for a desirable application. For example, upon initialization or reset, warning system 10 may retrieve system data from non-volatile memory, place the system data into working memory, reset each functional block, request additional user information, inform the user that reset has started, clear previously stored hazard locations, request a user location, and shutoff all alarms. In an exemplary embodiment, at initialization and/or reset, warning system 10 retrieves user preferences and system values from non-volatile memory, stores the retrieved values into working memory, and enables signal receiving device 12, user interface 14, and alarm interface 16.

Providing warning system 10 with user input may be accomplished using any algorithm and/or series of steps for a desired application. For example, warning system 10 may prompt the user for desired information, provide a menu for user controlled data input, confirm the correct entry of data, advise of incorrect entry of data, parse data from a file and/or data packet, provide default values, and poll a software and/or hardware flag to determine if user input is available. In an exemplary embodiment, warning system 10 prompts the user for input for a mode, accepts the user input, stores the user input, selects the next mode, and repeats the process until data for all modes and/or user preferences have been entered.

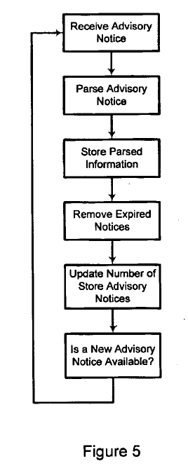

Advisory notices are received, stored, and processed using any algorithm, serial steps, and/or parallel steps for a desired application. For example, warning system 10 may accept advisory notices regularly, poll to determine if advisory notices are available, parse the advisory notices into information fields, modify the data of an information field, store advisory notices, store information fields, time stamp each advisory notice, determine an expiration time of an advisory notice, sort advisory notices by hazard type, remove expired advisory notices, and track the number of outstanding advisory notices. In an exemplary embodiment, referring to FIG. 5, warning system 10 polls to determine if an advisory notice is available to accept (step 512). If any advisory notice is available, warning system 10 accepts the advisory notice (step 502), parses the advisory notice into information fields (step 504), stores the parsed information fields (step 506), removes information related to expired advisory notices (step 508), and updates the number of store advisory notices (step 510).

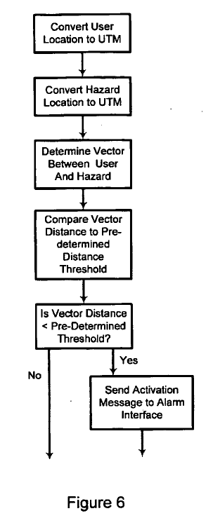

Proximity between any two locations may be determined for any purpose. For example, hazard locations may be compared with a user location and the hazard location eliminated if the distance between the two locations exceeds a predetermined threshold. Hazard locations may also be compared with a user location and an alarm set if the distance between the two is less than a predetermined distance. Proximity between any two locations may be determined in any manner. For example, converting the locations to a common format, subtracting the locations, determining the geometric distance between the locations, calculating a vector between the locations, and comparing locations. In an exemplary embodiment, referring to FIG. 6, proximity of a user location to a hazard location may be calculated by converting the user location to a UTM coordinate (step 602), converting each hazard location to a UTM coordinate (step 604), determining a vector, distance and direction, between the user location and a hazard location (step 606), comparing the vector distance to the predetermined distance threshold (step 608), and if the vector distance is less than the predetermined threshold (step 610), generating an active state message for the alarm interface 16 (step 612). In another embodiment, the locations are expressed as five-digit zip codes where proximity is measured by determining if the user location zip code is the same as the hazard location zip code.

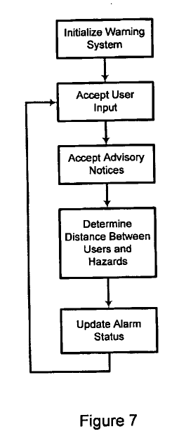

During stationary operation, warning system 10 may receive the user location at initialization and not have any further need for the user location updates. Stationary warning system 10 may operate in any manner suitable for the application. For example, stationary warning system 10 may initialize and/or reset, accept any available user input including user location, accept any available advisory notices, determine proximity, update alarm status, transmit a signal to emergency personnel, monitor power supply status, and provide periodic status reports. In an exemplary embodiment, referring to FIG. 7, warning system 10 initializes and/or resets (step 702), accepts any available user input including user location (step 704), accepts any available advisory notices (step 706), determines the distance between the user location and each hazard location (step 708), and updates alarm status (step 710). In another embodiment, warning system 10 is incorporated into a smoke alarm and in addition to monitoring public and/or subscription service advisory notices, warning system 10 also monitors the smoke alarm and provides an appropriate alarm response in the event of a fire. Similarly, warning system 10 may be integrated into other types of systems, for example, a carbon monoxide alarm, a burglar alarm, a freezer frozen food alarm, a cable modem, an internet router, an internet gateway, a radio, and a video storage device.

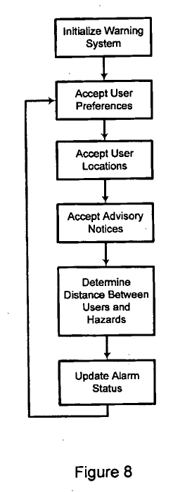

Mobile warning system 10 operation is configured to include periodic user location updates after initialization. Operation of a mobile warning system may be similar to the operation of a stationary warning system 10 except for the periodic update of the user location. The frequency of mobile user location updates may depend on a variety of factors, for example, user speed, user vector of travel, number of mobile users, hazard locations, hazard movement with respect to users, and intensity of the hazards. In an exemplary embodiment, referring to FIG. 8, warning system 10 initializes and/or resets (step 802), accepts any available user preferences (step 804), accepts any available user locations (step 806), accepts any available advisory notices (step 808), determines distance from each user location to each hazard location (step 810), and updates alarm status (step 812). In one embodiment, the method of FIG. 8 may be used where warning system 10, in its entirety, is mobile. In another embodiment, the method of FIG. 8 may support warning system 10 comprising multiple mobile users with mobile portion 32 and stationary portion 42 as shown in FIG. 3.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; advisory notice data; and/or like data useful in the operation of the system. As those skilled in the art will appreciate, processor 18 implemented as a computer may include an operating system (e.g., Windows NT, Windows 95/98/2000, Windows CE, OS2, UNIX, Linux, Solaris, MacOS, etc.) as well as various conventional support software and drivers typically associated with computers. Processor 18 implemented using a microprocessor may use a real time operating system, for example, QNX Nuetrino, VxWorks, eCOS, INTime, IRIX, Fusion RTOS, ThreadX, and RTLinux. The warning system may include any suitable personal computer, network computer, workstation, minicomputer, mainframe, microprocessor, digital signal processor, programmable logic array, or the like. In an exemplary embodiment, access is through a network or the Internet through a commercially-available web-browser software package.

As used herein, the term “network” shall include any electronic communications means which incorporates both hardware and software components of such. Communication among the parties may be accomplished through any suitable communication channels, such as, for example, a telephone network, an extranet, an intranet, Internet, point of interaction device (point of sale device, personal digital assistant (e.g., Palm Pilot®), cellular phone, kiosk, etc.), online communications, satellite communications, off-line communications, wireless communications, transponder communications, local area network (LAN), wide area network (WAN), networked or linked devices, keyboard, mouse and/or any suitable communication or data input modality. Moreover, although the system is frequently described herein as being implemented with TCP/IP communications protocols, the system may also be implemented using IPX, Appletalk, IP-6, NetBIOS, OSI or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, Dilip Naik, Internet Standards and Protocols (1998); Java 2 Complete, various authors, (Sybex 1999); Deborah Ray and Eric Ray, Mastering HTML 4.0 (1997); and Loshin, TCP/IP Clearly Explained (1997) and David Gourley and Brian Totty, HTTP, The Definitive Guide (2002), the contents of which are hereby incorporated by reference.

The various system components may be independently, separately or collectively suitably coupled to the network via data links which includes, for example, a connection to an Internet Service Provider (ISP) over the local loop as is typically used in connection with standard modem communication, cable modem, Dish networks, ISDN, Digital Subscriber Line (DSL), or various wireless communication methods, see, e.g., Gilbert Held, Understanding Data Communications (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

As used herein, “transmit” or “broadcast” may include sending electronic data from one system component to another over a network connection. Additionally, as used herein, “data” or “signals” may include encompassing information such as commands, queries, files, data for storage, and the like in digital or any other form.

The system contemplates uses in association with web services, utility computing, pervasive and individualized computing, security and identity solutions, autonomic computing, commodity computing, mobility and wireless solutions, open source, biometrics, grid computing and/or mesh computing.

Access levels may be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, data set annotations indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a stand alone interaction device configured to add, delete, modify, or augment the data in accordance with the header or trailer. As such, in one embodiment, the header or trailer is not stored on the transaction device along with the associated issuer-owned data but instead the appropriate action may be taken by providing to the transaction instrument user at the stand alone device, the appropriate option for the action to be taken. The system may contemplate a data storage arrangement wherein the header or trailer, or header or trailer history, of the data is stored on the transaction instrument in relation to the appropriate data.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

Warning system 10 may be equipped with an Internet browser connected to the Internet or an intranet using standard dial-up, cable, DSL or any other Internet protocol known in the art. Transactions originating at a web client may pass through a firewall in order to prevent unauthorized access from users of other networks. Further, additional firewalls may be deployed between the varying components of CMS to further enhance security.

Firewall may include any hardware and/or software suitably configured to protect CMS components and/or enterprise computing resources from users of other networks. Further, a firewall may be configured to limit or restrict access to various systems and components behind the firewall for web clients connecting through a web server. Firewall may reside in varying configurations including Stateful Inspection, Proxy based and Packet Filtering among others. Firewall may be integrated within a web server or any other CMS components or may further reside as a separate entity.

The system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, Macromedia Cold Fusion, Microsoft Active Server Pages, Java, COBOL, assembler, PERL, Visual Basic, SQL Stored Procedures, extensible markup language (XML), with the various algorithms being implemented with any combination of data structures, objects, processes, routines or other programming elements. Further, it should be noted that the system may employ any number of conventional techniques for data transmission, signaling, data processing, network control, and the like.

As will be appreciated by one of ordinary skill in the art, the system may be embodied as a customization of an existing system, an add-on product, upgraded software, a stand alone system, a distributed system, a method, a data processing system, a device for data processing, and/or a computer program product. Accordingly, the system may take the form of an entirely software embodiment, an entirely hardware embodiment, or an embodiment combining aspects of both software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

Although the description above contains many details, these should not be construed as limiting the scope of the invention but as merely providing illustrations of some of the exemplary embodiments of this invention. Therefore, it will be appreciated that the scope of the present invention fully encompasses other embodiments which may become obvious to those skilled in the art, and that the scope of the present invention is accordingly to be limited by nothing other than the appended claims. Any reference herein to an element in the singular is not intended to mean “one and only one” unless explicitly so stated, but rather “one or more.” All structural and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present invention.

What is claimed is:

1. A warning system, comprising:
a signal receiving device configured to receive an advisory notice, said advisory notice having a hazard location;
a user interface configured to receive at least one of a user location and a user preference;
an alarm interface configured to control an alarm; and,
a processor interfacing with said signal receiving device, said user interface, and said alarm interface, wherein said processor determines a distance between said user location and each of said hazard locations, wherein said processor enables said alarm interface to activate said alarm when said distance of said user location and a hazard locations is less than a predetermined distance.

2. The warning system of claim 1, wherein said advisory notices are received without user registration.

3. The warning system of claim 1, wherein said signal receiving device receives said advisory notice from at least one of a public source, a subscription service, and a proprietary source.

4. The warning system of claim 1, wherein said advisory notice is transmitted using at least one of a radio, a AM modulated, a FM modulated, a satellite, a microwave, a television, an analog cable, a digital cable, a spread spectrum, an infrared, a sonar, a local area network, a wide area network, an internet, and a wireless network signal.

5. The warning system of claim 1, wherein said advisory notice is transmitted using at least one of TCP/IP, 802.11, Bluetooth, Ethernet, token ring, and IPX communication protocol.

6. The warning system of claim 1, wherein said user interface is configured to report at least one of user location, user preferences, available services, hazard location, and distance between said user location and said hazard location.

7. The warning system of claim 1, wherein at least one of said signal receiving device, said user interface, said alarm interface, said processor, and said power supply is integrated into at least one of a smoke detector, a carbon monoxide detector, a security system, a freezer frozen food detector, a cable modem, an internet router, an internet gateway, a radio, and a video storage device.

8. The warning system of claim 1, further comprising a subscription services manager.

9. The warning system of claim 1, wherein at least a portion of said user interface is mobile.

10. The warning system of claim 1, wherein said user interface receives said user location from a GPS receiver.

11. The warning system of claim 1, wherein said format of said user location and each of said hazard locations is at least one of a zip code, a zip code plus a four digit extension, a postal code, a telephone area code, a telephone area code with prefix, a street address, a latitude/longitude coordinate, a Universal Transverse Mercator coordinate, a Universal Polar Stereographic coordinate, a Military Grid Reference System coordinate, a Maidenhead coordinate, and a Ordnance Survey Great Britain coordinate.

12. The warning system of claim 1, further comprising a power supply interfacing with said signal receiving device, said user interface, said alarm interface, and said processor, said power supply configured to provide continuous power.

13. The warning system of claim 1, further comprising a power supply, wherein said power supply utilizes power from at least one of an electrical line, a fuel cell, a battery, a solar cell, a combustible gas, a source of geothermal heat, and a source of hydraulic power.

14. A method for providing alerts, comprising:
selecting a warning system configured to receive an advisory notice and to operate continuously;
receiving said advisory notice having a hazard location;
receiving a user location;
determining a distance between said user location and said hazard location;
activating an alarm when said distance between said user location and said hazard location is less than a predetermined distance.

15. The method of claim 14, wherein said warning system receives said advisory notice without registration.

16. A method for paying for subscription services that do not require registration, comprising:
selecting a warning system having a subscription services manager, wherein a unique identification number identifies said subscription services manager;
selecting desired services from said services provided by a subscription service;
paying for said desired services;
associating payment for said desired services with said unique identification number used to identify said subscription services manager;
communicating said desired services associated with said unique identification number to said subscription services manager; and,
configuring said subscription services manager to enable said warning system to utilize said desired services.

17. The method of claim 16, wherein said paying step may be accomplished using at least one of cash, a credit card, a money order, a check, a third party payment service, and a subscription service related pre-paid card.

18. The method of claim 16, wherein said communicating step may be accomplished by at least one of swiping said pre-paid services card in said warning system, sending an advisory notice to said warning system to enable said desired services, and connecting said subscription services manager to a subscription services database.
